(19) United States
(12) Patent Application Publication
(10) Pub. No.: US 2002/0187807 A1
(43) Pub. Date: Dec. 12, 2002

(54) Clip-on/clip-in smart module

(76) Inventors: Richard D. La Torre, Oakland, NJ (US); Tuan Nguyen, North Plainfield, NJ (US); William Bruce Weaver, Grayslake, IL (US); Michael J. Hughes, Neshanic Station, NJ (US)

Correspondence Address: MOTOROLA INC, 600 NORTH US HIGHWAY 45, LIBERTYVILLE, IL, 60048-5343, US

(21) Appl. No.: 09/876,398

(22) Filed: Jun. 7, 2001

(51) Int. Cl. H04M 1/00

(52) U.S. Cl. 455/558; 455/349; 455/90

(57) ABSTRACT

A smart module for connection to a portable telephone has a module housing with a back side and a front side. The front side is adapted for removably securing the module housing to a battery attachment region of the portable telephone. The smart module has a printed circuit board that provides desired electronic functions to enhance, change or otherwise alter those of the portable telephone. The smart module has a module connector section that is electronically coupled to the module printed circuit board. The module connector section connects with a corresponding in-phone connector section within the battery attachment region when the smart module is attached to the battery attachment region of the phone. The connector sections couple the module printed circuit board to electronic circuitry of the portable telephone when the module is secured to the telephone.

### FIELD OF THE INVENTION

The present invention relates generally to portable telecommunication devices, and more particularly to a smart module accessory that connects with and clips onto a cellular telephone or the like.

### BACKGROUND OF THE INVENTION

Portable telecommunication devices such as cellular telephones and pagers are known in the art. These types of devices provide users with wireless communication capability by transmitting and receiving signals according to their particular electronic characteristics. Use of these portable communication devices has become widely accepted in the marketplace.

Other electronic devices and wireless technologies are also available and becoming more common in the marketplace as well. Examples of such technology include hand held electronic organizers, e-commerce or magnetic strip card readers, radio or short-range communication devices, MP3 audio players with recordable memory, wireless access to e-mail and Internet services. Obviously, other wireless technologies are becoming available and will continue to be developed.

Traditionally, if a user travels and desires access to data stored in several different devices, such as their cell phone, personal organizer, and personal computer, each item must be carried with them. Carrying all of these items, including the appropriate accessories and batteries for each can become quite cumbersome. One or more of the devices can easily become lost, misplaced, dropped, or otherwise damaged during travel.

Technology is being developed that will permit a portable telephone to exchange data with or to store data from one or more other electronic devices so that only the portable telephone need be carried. For example, using such technology, a user can access data from a personal organizer, a computer, an e-mail service, or the like using only their portable phone. Technology has also been developed for what is known as e-commerce wherein a magnetic card reading device can be connected a portable telephone in order to exchange data with retailers or the like to make purchases using only a portable telephone and a credit card remote from the retailer. These technologies require connection of an accessory module or smart module to the telephone to upgrade or alter the electronic characteristics of the portable phone.

U.S. Pat. No. 5,832,388, assigned to the assignee of the present invention, discloses a portable radiotelephone device which includes a radiotelephone housing, a separate battery housing attached to the telephone housing, and a third separate accessory module coupled to the radiotelephone's circuitry and to the battery. Accessory features added via the accessory circuitry can communicate with the radiotelephone's circuitry. The disclosed device requires a separate latching mechanism for the accessory housing to the radiotelephone resulting in a cumbersome attachment of the accessory housing to the telephone and battery assembly. The entire assembled device looks different than an ordinary telephone and can be spotted easily for theft or other illicit purposes. The size of the device, the complexity of the signal connections, and the complexity of the mechanical latching mechanisms are deterrents for long-term commercial applicability of the device.

There is thus a need for an improved portable telecommunication device that is adapted to attach to a variety of other portable electronic device modules. There is also a need for an accessory or smart module that can easily connect with a portable telephone to provide enhanced or altered electronic capability.

### BRIEF DESCRIPTION OF THE DRAWINGS

FIG. 1 is a perspective view from the back of a portable cellular telephone and a smart module constructed according to one example of the teachings of the present invention.

FIG. 2 is a partially exploded view from the back of the telephone and smart module shown in FIG. 1, and including an optional battery pack.

FIG. 3 is a perspective, partially exploded view from the front of the telephone rear housing of the telephone shown in FIGS. 1 and 2.

FIG. 4 is a perspective view from the front of the smart module shown in FIG. 2.

FIG. 5A is an exploded view from the front of the smart module shown in FIG. 2.

FIG. 5B is an exploded view from the back of the smart module shown in FIG. 5A.

FIG. 6 is a perspective view of one side of a module connector section of a connector constructed according to one example of the teachings of the present invention.

FIG. 7 is a perspective view of the opposite side of the module connector section shown in FIG. 6.

FIG. 8 is a perspective view of one side of an in-phone connector section of a connector constructed according to one example of the teachings of the present invention.

FIG. 9 is a view of the connector sections shown in FIGS. 6-8 just prior to assembly to one another.

FIG. 10A is a view from one side of the connector sections shown in FIG. 9 at initial engagement to one another.

FIG. 10B is a view from the opposite side of the connector sections shown in FIG. 10A.

FIG. 11 is a back view of the telephone rear housing and smart module assembly shown in FIG. 1 upon beginning an engagement stroke when installing the smart module.

FIGS. 12A-12D illustrate various longitudinal cross sections taken respectively along lines A-A, B-B, C-C, and D-D of FIG. 11.

FIGS. 13A-13D illustrate enlarged views taken from circles A, B, C, and D of FIGS. 12A-12D, respectively, showing the engagement condition at various locations across the connector sections for the initial engagement of the smart module shown in FIG. 11.

FIG. 14 is a back view of the telephone rear housing and smart module assembly shown in FIG. 1 with the smart module fully installed and the connector sections fully engaged.

FIGS. 15A-15D illustrate various longitudinal cross sections taken respectively along lines A-A, B-B, C-C, and D-D of FIG. 14.

FIGS. 16A-16D illustrate enlarged views taken from circles A, B, C, and D of FIGS. 15A-15D, respectively, showing the engagement condition at various locations across the connector sections for the fully engaged smart module shown in FIG. 14

FIG. 17 is a back view of the telephone rear housing and smart module assembly shown in FIG. 1 upon beginning a disengagement stroke when removing the smart module.

FIGS. 18A-18D illustrate various longitudinal cross sections taken respectively along lines A-A, B-B, C-C, and D-D of FIG. 17.

FIGS. 19A-19D illustrate enlarged views taken from circles A, B, C, and D of FIGS. 18A-18D, respectively, showing the engagement condition at various locations across the connector sections for the partially disengaged smart module shown in FIG. 17.

### DETAILED DESCRIPTION OF THE PREFERRED EMBODIMENTS

A smart module as described herein and as constructed according to the present invention is an accessory device that can be added to a portable telephone or other portable telecommunication device. The smart module can be provided with electronic circuitry to perform virtually any conceivable function through the telephone, to exchange data between the telephone and another device, to upgrade existing characteristics of the telephone or the like. A number of examples of such smart modules are described herein.

One example of the present invention is directed generally to a smart module that can attach directly to a portable telephone via the phone's battery cover attachment region in place of the conventional or standard battery cover. The smart module and the portable telephone each include a section of a connector that provides data communication capability between the module and the phone when the module is attached to the phone. The connector sections automatically engage and disengage as the module is attached and removed respectively, from the telephone or telecommunication device.

The exemplary embodiments described herein utilize a portable cellular telephone to illustrate aspects and features of the invention. The cellular telephone shown in the drawing figures and described herein is utilized only as an aid in describing the invention. The scope of the invention is not to be limited only to a portable cellular telephone device and certainly not only to the particular phone illustrated and described. Similarly, the smart module shown in the drawings and described herein can be virtually any type of accessory module added to or connected with the telecommunication device.

Certain directional and orientation terms are utilized throughout the description. Terms such as “back”, “front”, “top”, “bottom”, and “side” are used herein to define the relationship of various features and components of the invention. These terms are not intended to limit the scope of the invention to the position or orientation stated. Instead, the terms are used to relate one feature or element to another.

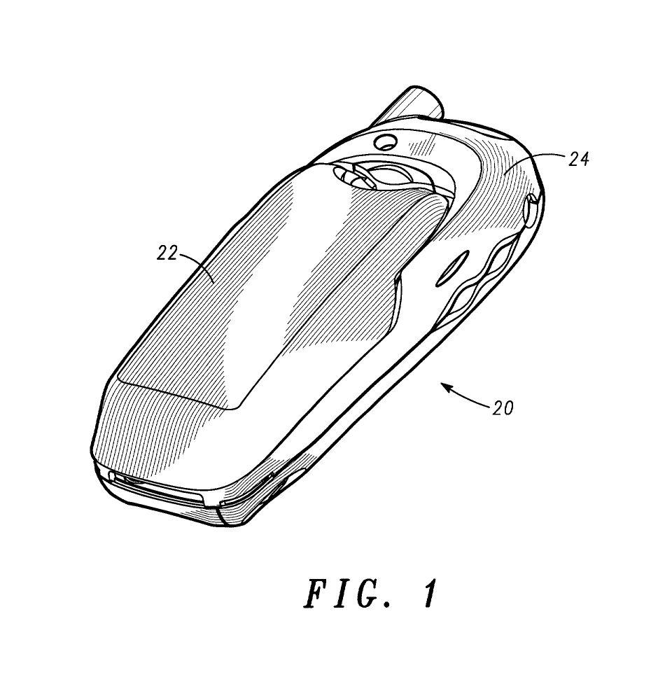

Referring now to the drawings, FIG. 1 illustrates a portion of a portable cellular telephone assembly 20 in perspective view. The assembly 20 as shown includes a smart module 22 and a portable telephone rear housing 24 assembled to one another. The remaining portions of the portable telephone are not illustrated in the drawings, as they are not necessary to describe the various aspects of the present invention. In FIG. 1, the telephone assembly 20 including the smart module 22 and rear housing 24 are shown from the back.

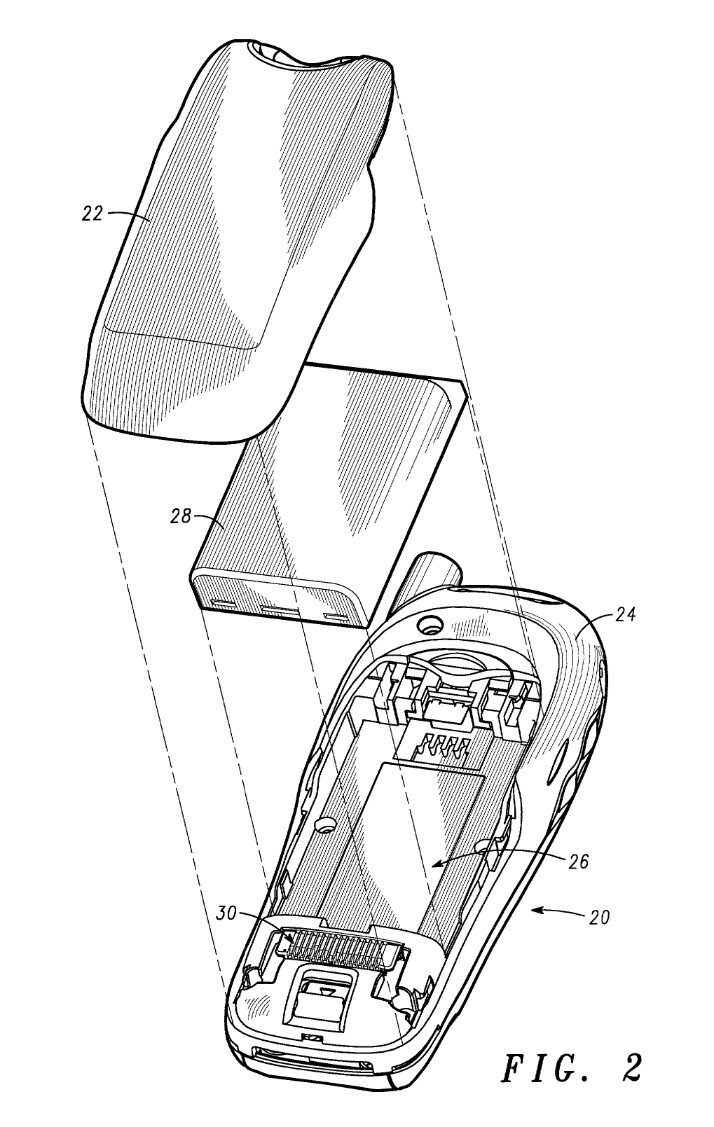

FIG. 2 illustrates a perspective view of the telephone assembly 20 wherein the smart module 22 and the rear phone housing 24 are separated. The back of the rear housing 24 is exposed and defines generally a battery attachment region 26 of the portable telephone. During normal or standard use, the battery attachment region 26 is adapted to receive a battery pack 28. The battery pack 28 can include a separate cover (not shown) that can be similar or identical in appearance to the module 22 shown in FIG. 2. Alternatively, the battery pack 28 can include an integral cover (not shown) and latching or attachment mechanism (also not shown) for securing the battery in place on the telephone. The telephone 20 and smart module 22 can be utilized with the battery pack 28, or, more typically when powered externally, without the battery back

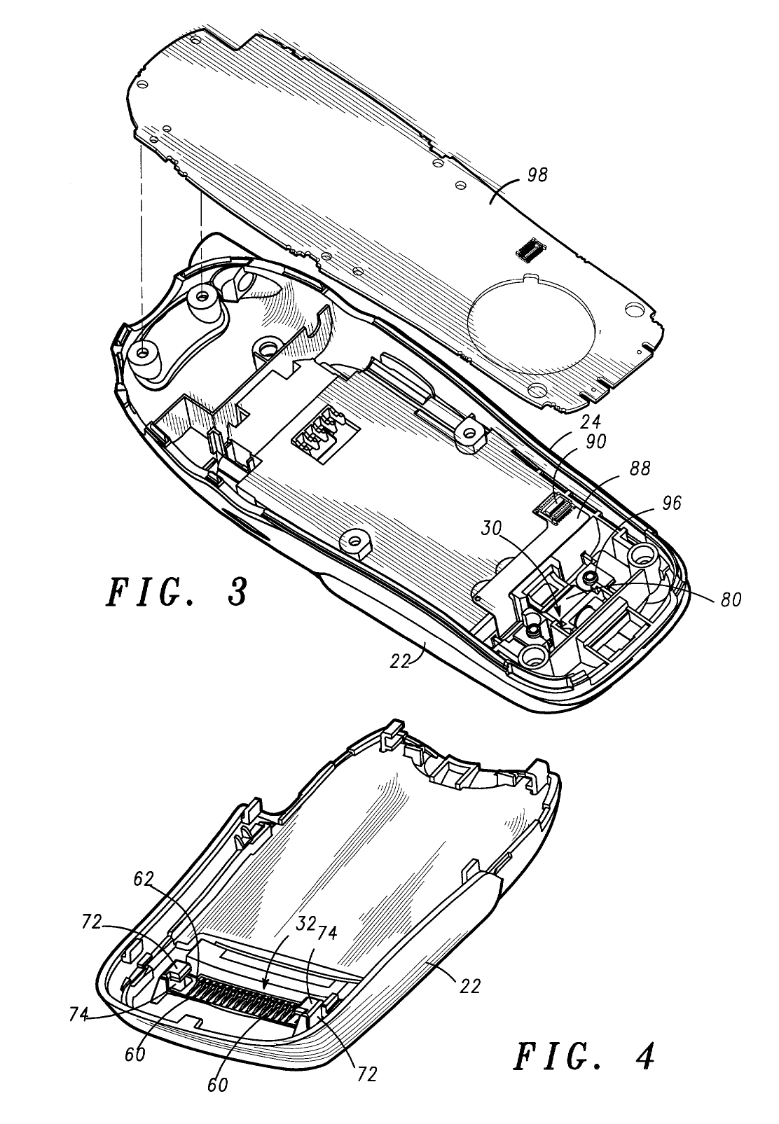

By removing the smart module 22 from the rear telephone housing 24, one example of an in-phone connector section 30 is exposed. According to the terminology used herein, the back of the in-phone connector section 30 is illustrated and faces the smart module 22. FIG. 3 illustrates the rear phone housing 24 from the front side. With the remaining portions of the portable telephone not shown in the drawings, the front of the in-phone connector section 30 is exposed. Various details of the in-phone connector section 30 are described in detail below.

FIG. 4 illustrates a view from the front of a bottom portion of the smart module 22 after removal from the rear housing 24 of the telephone assembly 20. A front of a module connector section 32 is exposed and which connects with the in-phone connector section 30 and faces the rear phone housing 24 when assembled. The module connector section 32 engages the in-phone connector section 30 when the two components are attached to one another.

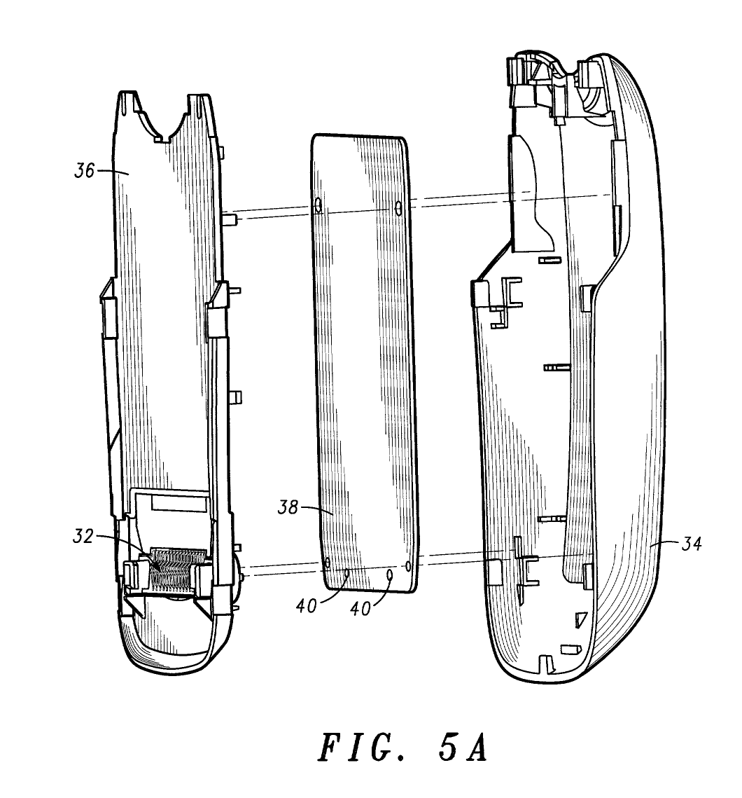

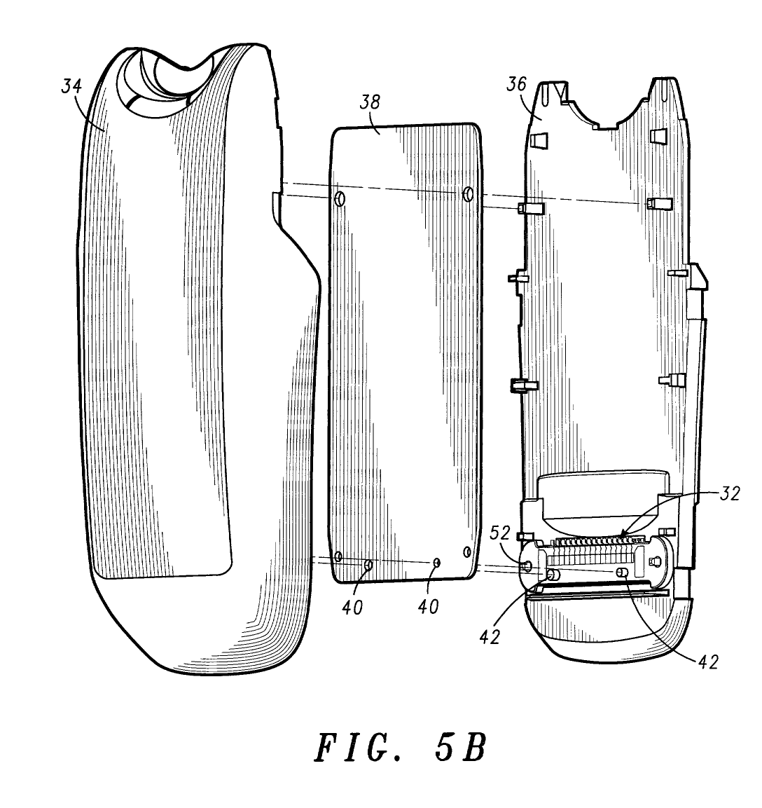

FIGS. 5A and 5B illustrate an exploded view of the smart module 22. FIG. 5A shows the smart module 22 from the front including the separate components of the module. Similarly, FIG. 5B illustrates the smart module components from the back. The smart module generally includes a cover or module housing 34 and a mounting section 36 that attaches to the module housing. The smart module also has a printed circuit board 38 sandwiched between the housing 34 and the mounting section 36. The module printed circuit board 38 carries electronic circuitry that corresponds to functional aspects of a particular smart module.

The mounting section 36 is attached, adhered, or fastened to the module housing 34 and provides protection for the printed circuit board 38 sandwiched between the module housing and mounting section. The mounting section can be secured by conventional fasteners, snap-fit connectors provided directly on the components, sonic or heat welding, or any other suitable means.

The printed circuit board can include a locating and attachment mechanism to properly position and secure the board relative to the mounting section 36, the module housing 34, or both. In the illustrated example, a pair of guide openings 40 are provided on the printed circuit board 38 each for receiving a corresponding guide pin 42 carried either on the mounting section 36 (as shown), on the module housing (not shown), or both. In the illustrated example, the guide pins 42 are provided on the back of the module connector section 32 so that when the connector section is attached to the mounting section 36, the printed circuit board 38 will be properly aligned and electrically connected to the module connector section.

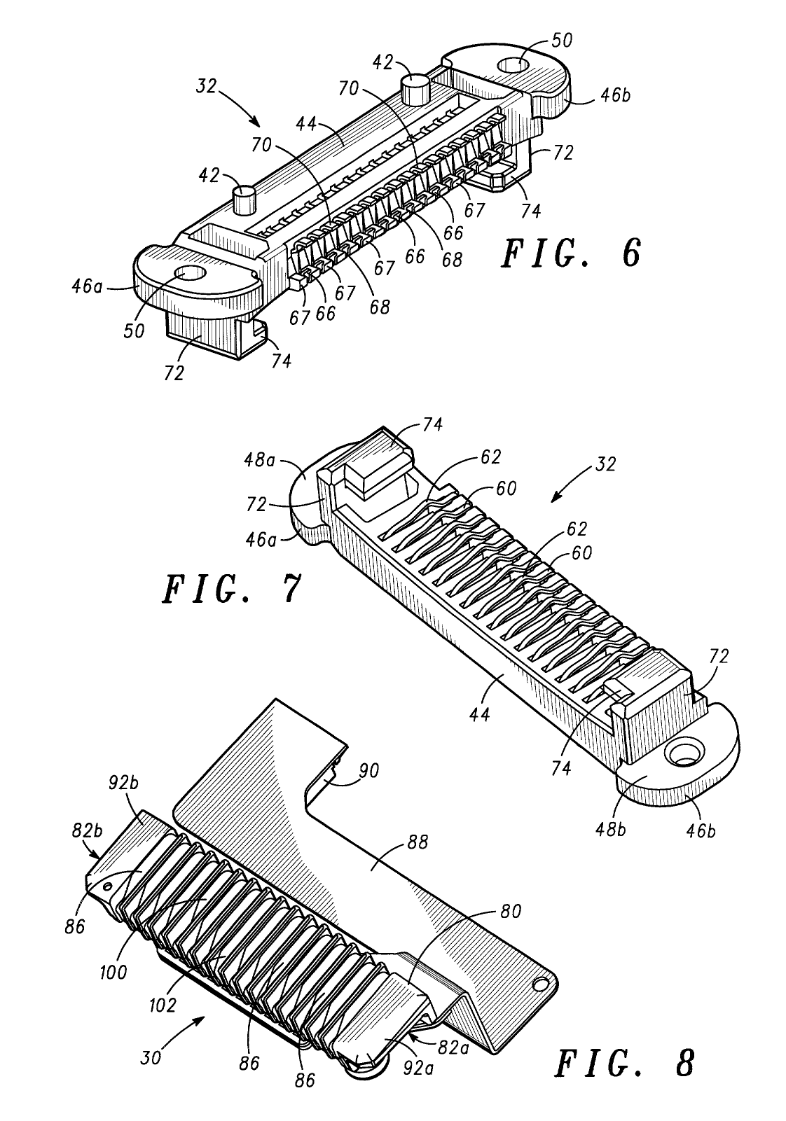

FIGS. 6 and 7 illustrate a perspective view of the module connector section 32 according to one example of the present invention. FIG. 6 illustrates the connector section 32 from the back, as defined herein, and FIG. 7 illustrates the front of the connector section. The module connector section includes an elongate module connector body 44 which in one example is of a molded plastic construction. The body 44 has opposed ends 46a and 46b wherein each of the ends 46a and 46b defines a mounting pad 48a and 48b, respectively, having a mounting surface facing toward the front of the connector body 44. These mounting pads 48a and 48b rest against a corresponding surface (not shown) of the mounting section 36 of the module 22 when installed.

Each of the mounting pads 48a and 48b includes a through-opening 50. A pair of corresponding posts 52 extend from the mounting section 36 and are received in the respective opening 50 to assemble the module connector section 32 to the mounting section 36. The orientation and arrangement of the posts and openings can be reversed such that the posts are provided on the connector body and the openings are provided on the mounting section. In addition, other attachment or mounting arrangements can also be utilized. The connector body 44 is secured to the mounting section 36 by a mechanical snap fit between the posts 52 and openings 50 or by an appropriate plastic or sonic welding process. Other fastening or attachment means, such as by soldering to the printed circuit board, can be utilized without departing from the spirit and scope of the invention.

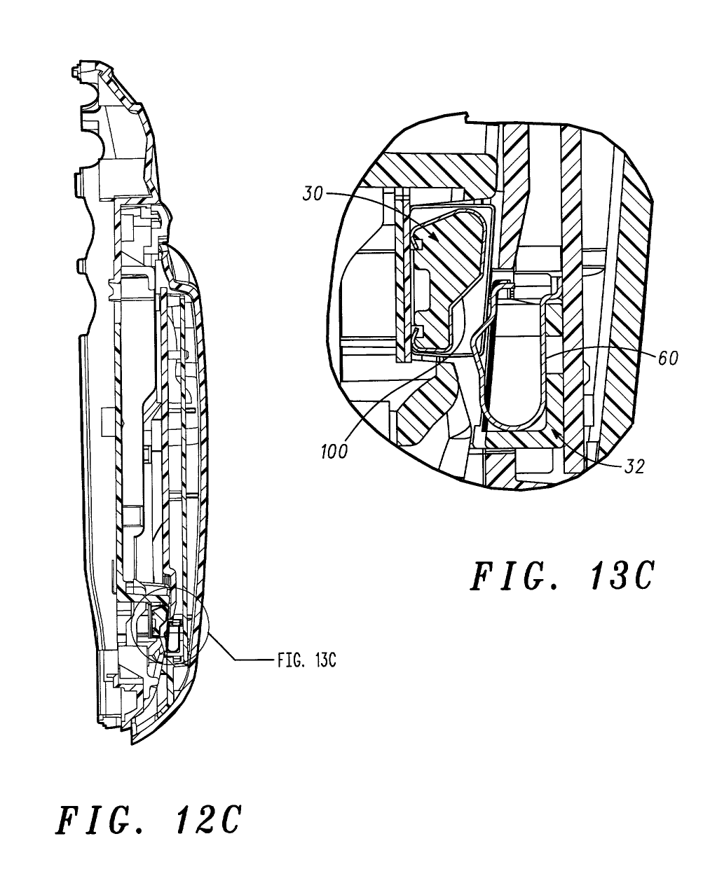

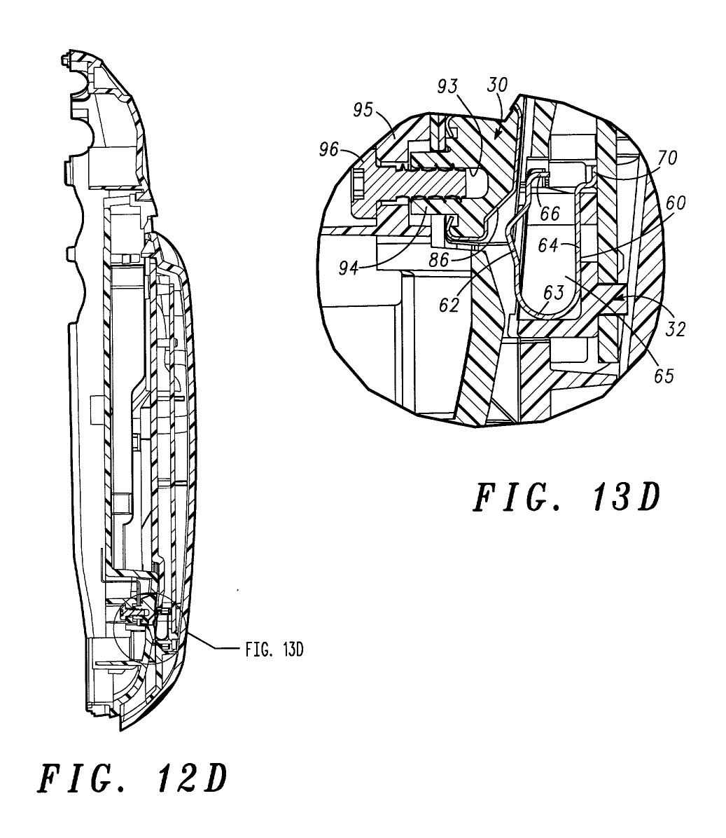

The elongate mid-section of the body 44 extending between the opposed ends 46a and 46b carries a plurality of spring contacts 60 each arranged having a resilient portion 62 extending outward from the front of the connector body. The resilient portions 62 can be flexed toward the body 44 and will spring back away from the body when released. Referring briefly to FIG. 13D, a side representation of one of the spring contacts 60 is shown. Each contact has a curvilinear shape, generally a U-shape, with a front defining the resilient portion 62. A curved bottom 63 and a back 64 of each spring contact 60 is received within a corresponding interior slot 65 of the connector body 44.

As shown in FIGS. 6 and 13D, a first end 66 of each of the spring contacts 60 is exposed near the front of the body 44 and bends or extends toward the back of the body. Each end 66 is received within a gap formed between tabs 67 extending from the body on either side of each slot 65. The first ends 66 of the spring contacts 60 have flared edges 68 defining a T-shaped end. The flared edges 68 overlap the tabs 67 extending from the body to securely hold the spring ends 66 in place and to prevent the springs from being peeled away from the front of the body. This prevents damage to the spring contacts during use and when the front of the connector section 32 is exposed.

Also as illustrated in FIGS. 6 and 13D, the spring contacts 60 each have a second end 70 on the back 64 of the spring. The second ends 70 are exposed at the back of the connector body 44 defining electrical contacts. The electrical contacts or second ends 70 will bear against corresponding contacts (not shown) on the printed circuit board 38 (see FIG. 13D) when the connector section 32 for the module is installed and connected to the printed circuit board.

The connector body 44 of the module connector section 32 in one example is formed from a molded plastic material, as noted above. As will be evident to those skilled in the art, the particular material of the connector body is not essential to the present invention and can vary considerably. Various plastic materials can easily be used and are preferred because of their lightweight and non-conductive characteristics and are also preferred because they can be molded to fairly precise tolerances and to include virtually unlimited shape variations.

As shown in FIG. 7, the front of the module connector section 32 also has a pair of opposed and inwardly facing L-shaped legs 72 extending away from the front side of the body 44. Each of the legs 72 includes an in-turned flange section 74 that defines a gap G between the flange and the body 44. This gap G is for receiving a portion of the in-phone connector section 30 as described below.

FIG. 8 illustrates the back, as defined herein, of the in-phone connector section 30 constructed according to one example of the invention. The front of the in-phone connector section 30 is illustrated in FIG. 3 as installed in the rear housing 24. The in-phone connector section 30 has a connector body 80 with opposed ends 82a and 82b which cooperate with the ends 46a and 46b of the module connector section 32 when assembled as described below. In one example, the connector body 80 can also be made of a plastic material. The connector body 80 defines a plurality of grooves 84 extending in a vertical direction, as defined herein, relative to the connector body. Each groove 84 supports an electrical contact 86 for connection with a corresponding one of the spring contacts 60 of the module connector section 32 when assembled. Each of the electrical contacts is electrically coupled to a flexible circuit 88 which in turn carries a remote connector 90 on a distal end of the flex circuit. Each of the electrical contacts 86 corresponds to one pin of the remote connector 90 as is known in the art.

Each of the opposed ends 82a and 82b of the in-phone connector body 80 defines an extension 92a and 92b, respectively, that has an increasingly tapered thickness from the bottom to the top of the in-phone connector body. The mid-section of the connector body 80 between the opposed ends, including the grooves and contacts, also has a tapered or slightly angled surface, which is the back surface of the connector body, as defined herein. The angled or tapered front surface of the connector body coincides with the taper of the two extensions 92, such that the thickness of the connector body increases moving from the bottom to the top of the body, as can be seen in FIG. 9.

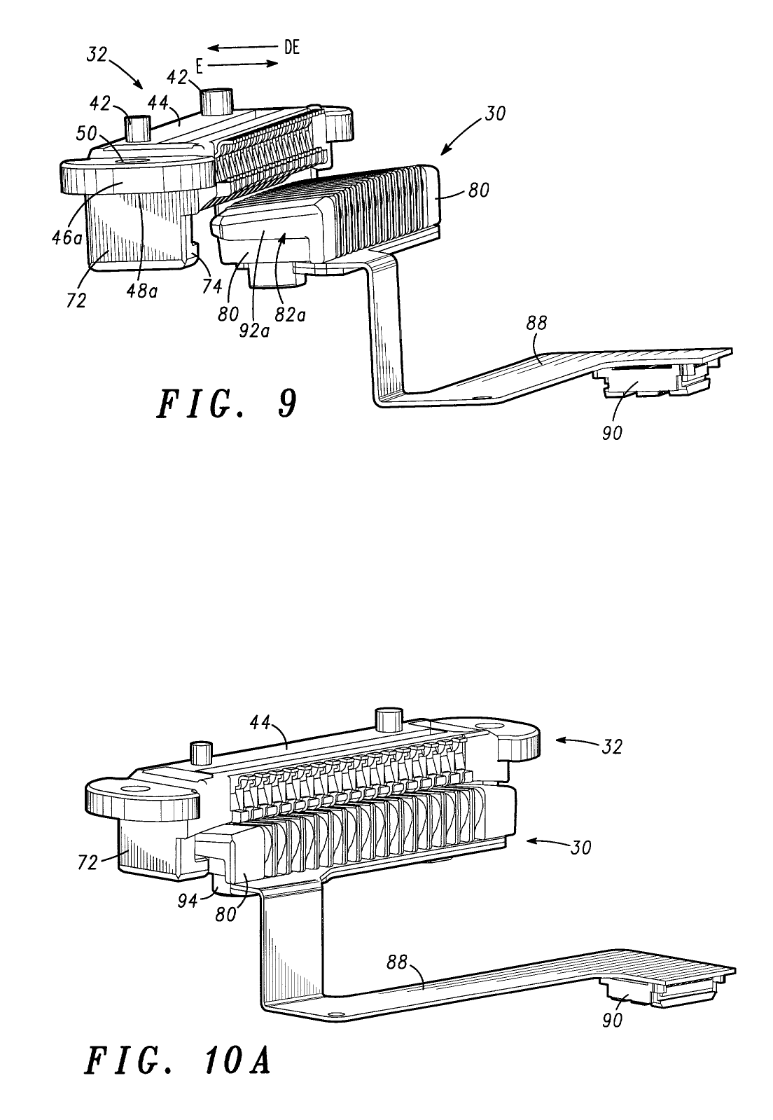

As shown in FIG. 3, the front of the in-phone connector section 30 faces the interior of the telephone assembly 20. The in-phone connector section is secured to the rear phone housing 24 by fastening the connector body 80 to the rear housing. Referring briefly to FIGS. 10B and 13D, the connector body 80 in this example includes a pair of bores 93 extending into the bottom of the connector body 80. Each of the bores 93 is surrounded by a cylindrical guide or boss 94 depending from the bottom of the body. The rear phone housing 24 includes a pair of corresponding openings 95 for receiving a corresponding one of the bosses 94. A screw 96 having a mechanical thread-forming design or profile is received in each bore 93 to secure the connector section 30 in place.

The flex circuit 88 and the remote connector 90 extend from the connector body 80 and, in one example, are not separately secured to the rear phone housing 24. The remote connector 90 connects to a corresponding connector (not shown) of the remaining portion of the telephone assembly 20 (not shown) to electrically connect the in-phone connector 30 and the telephone electronic circuitry (shown as circuitry or circuit board 98 in FIG. 3). The flex circuit 88 permits tolerance variation between the position of the in-phone connector section 30 and the remote connector 88, and hence the telephone electronic circuitry 98. Also, because the flex circuit 88 and remote connector 90 are not fixed directly to the phone housing, the flex circuit 88 also prevents damage to the various printed circuit boards, connectors, and circuits, such as when the telephone assembly 20 experiences a sudden or blunt impact. A rigid connection would be more likely to cause damage to components of the telephone assembly when experiencing such an impact.

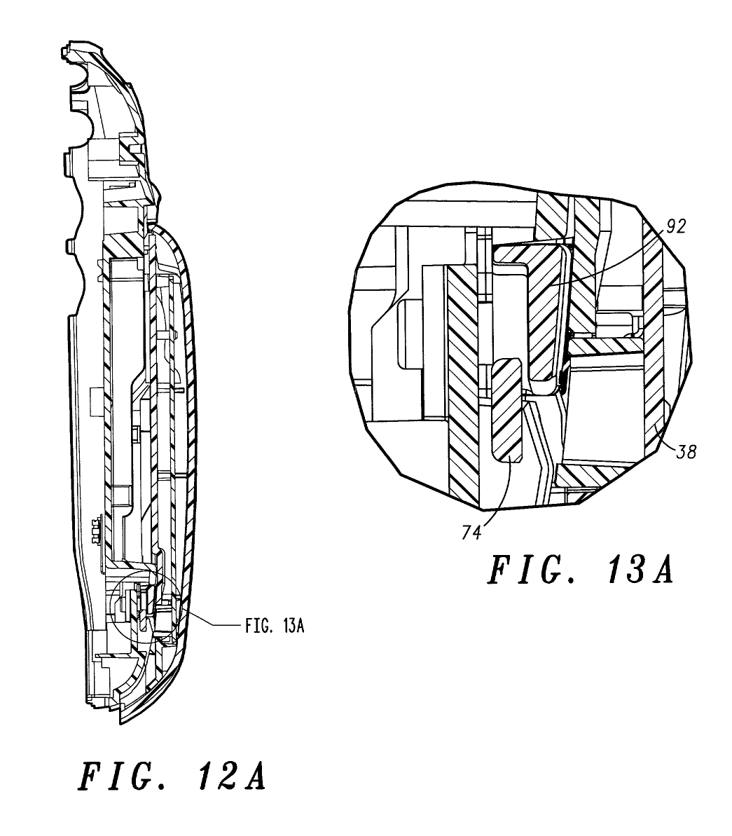

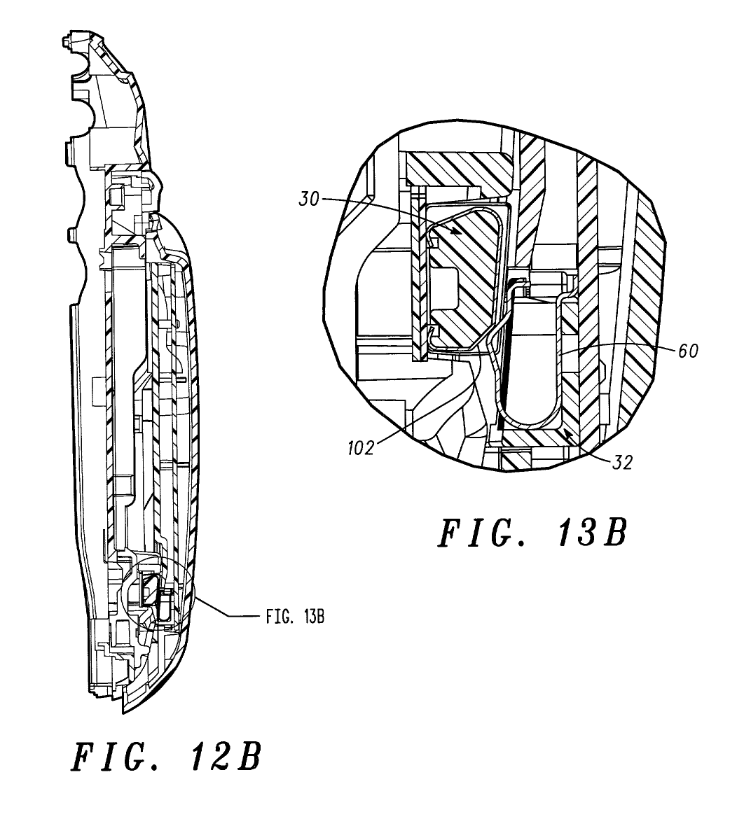

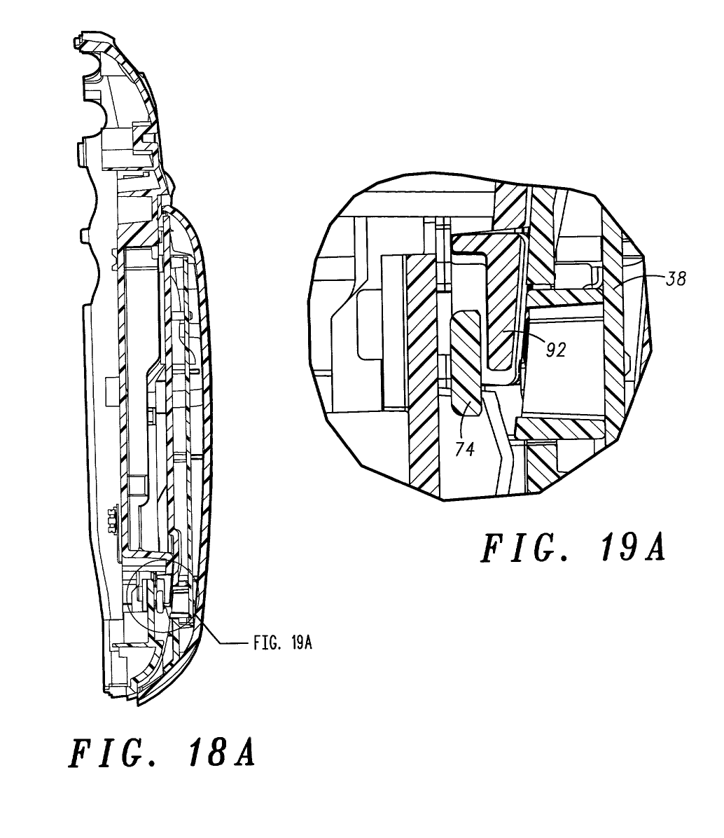

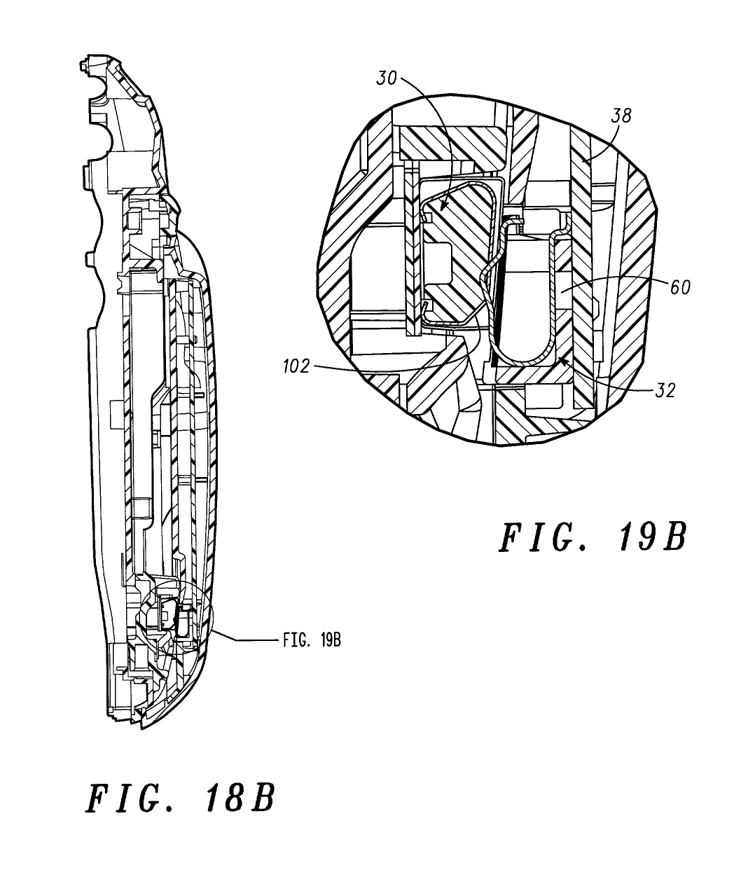

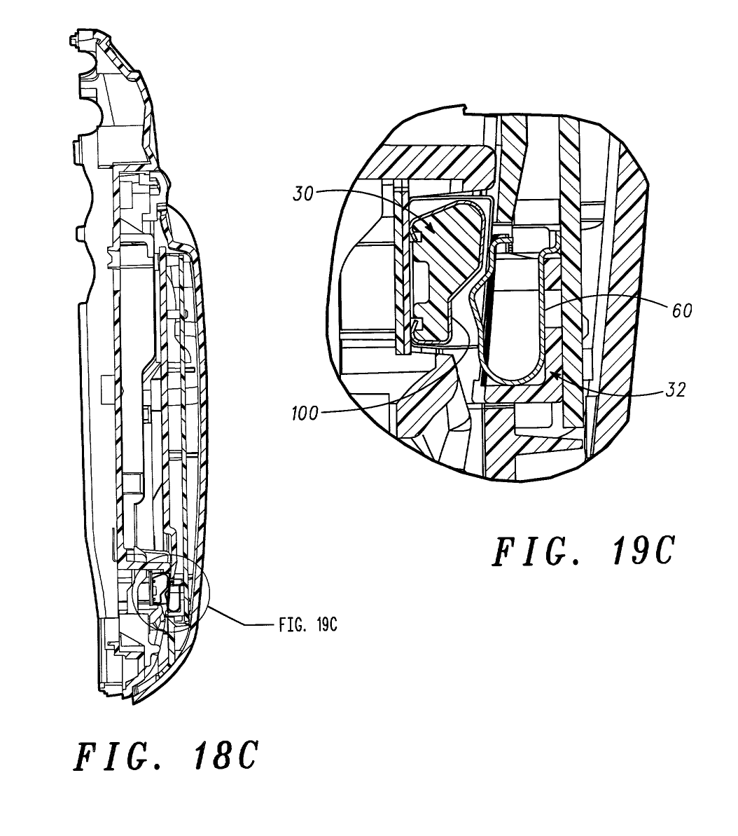

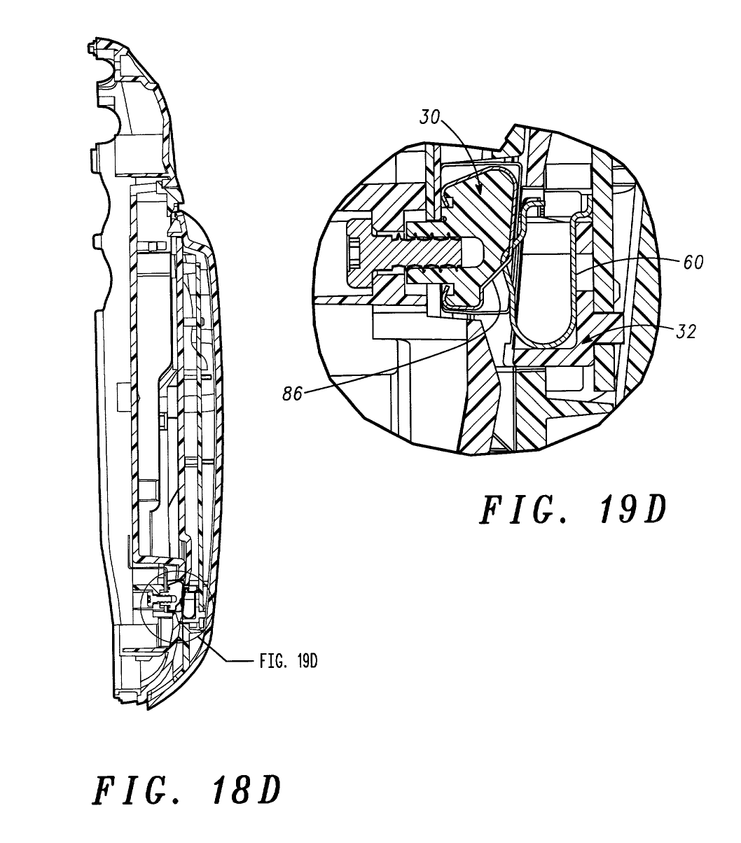

FIG. 2 illustrates the back of the in-phone connector section 30 as installed in the rear phone housing 24 wherein the electrical contacts 86 are exposed. As best illustrated in FIG. 8, most of the electrical contacts 86 are aligned with one another vertically relative to the in-phone connector body 80. However, two separate contacts are shown in a staggered orientation relative to the remaining electrical contacts 86. A signal pad or contact 100 is positioned at a different elevation relative to the remaining contacts 86 such that the contact 100 is the last to engage at the end of an engagement stroke of the components and contacts (see FIGS. 18A-18D and 19A-19D). The staggered position of the contact 100 ensures that it will be the last contact made during the engagement stroke and the first contact to break continuity during disengagement. Similarly, a ground pad or contact 102 is positioned at another different elevation relative to the remaining contacts 86 and 100, such that it is the first contact to engage at the beginning of the engagement stroke (see FIGS. 12A-12D and 13A-13D). The position of the ground contact 102 ensures that it will be the first contact made during engagement and the last contact to break during disengagement. The significance of the ground and signal pad positions is also described in greater detail below.

FIG. 9 illustrates the in-phone connector section 30 and the module connector section 32 just prior to engagement or just after disengagement. FIGS. 10A and 10B show the two connector sections 30 and 32 as assembled. Referring now to FIG. 9, and assuming that the in-phone connector section 30 remains in a fixed position, the module connector section 32 will be moved in the direction of arrow E for engaging the module to the telephone assembly and in the direction of arrow DE for disengaging the module from the telephone assembly. To simplify the description of the functional characteristics of the in-phone connector section 30 and module connector section 32, the module components and telephone assembly components are not shown in these figures.

When attaching the smart module 22 to the telephone rear housing 24, the two connector sections 30 and 32 are positioned near but offset from one another. The back of the in-phone connector section 30 and the front of the module connector section 32 are slid toward one another, and in this example, the module connector section 32 is moved in the direction of the arrow E. The gap defined between the in-turned flanges 74 of the legs 72 and module connector body 44 are configured to receive, bottom first, the corresponding extensions 92 of the in-phone connector section 30. Each of the spring contacts 60 is subsequently received within a respective one of the grooves 84 and contacts a corresponding one of the electrical contacts 86, 100 or 102. The ground pad 102 is positioned closest to the module connector section 32 and therefore contacts its corresponding spring contact 60 before any other connection between contacts is made. Next, the remaining electrical contacts 86 connect with their corresponding springs 60, and lastly, the signal contact 100 engages its corresponding spring contact 60. The legs 72 and the extensions 92 of the respective connector bodies 44 and 80 are intended to positively engage one another prior to any electrical contact between the springs 60 and the contacts 86, 100 and 102. Moving the module connector section relative to the in-phone connector section in the direction of arrow DE disengages the contacts and the legs and extensions in reverse order.

To further illustrate the connector assembly of the invention, FIG. 10A shows a top view of the assembled connector sections 30 and 32 and FIG. 10B illustrates a bottom view of the assembled connector sections. The extensions 92 are fully received within the gap between the in-turned flanges 74 of the legs 72 when the two connector components are assembled. The spring contacts 60 bear against the corresponding contacts 86, 100 or 102. The components are dimensioned such that the spring contacts 60 are forced slightly into the body 44 of the module connector section 32. The resiliency of the spring contacts forces the springs into positive engagement with the corresponding contacts of the in-phone connector. The electrical connections will remain intact because of the spring bias even when the telephone assembly 20 is subjected to a blunt or sudden impact during use.

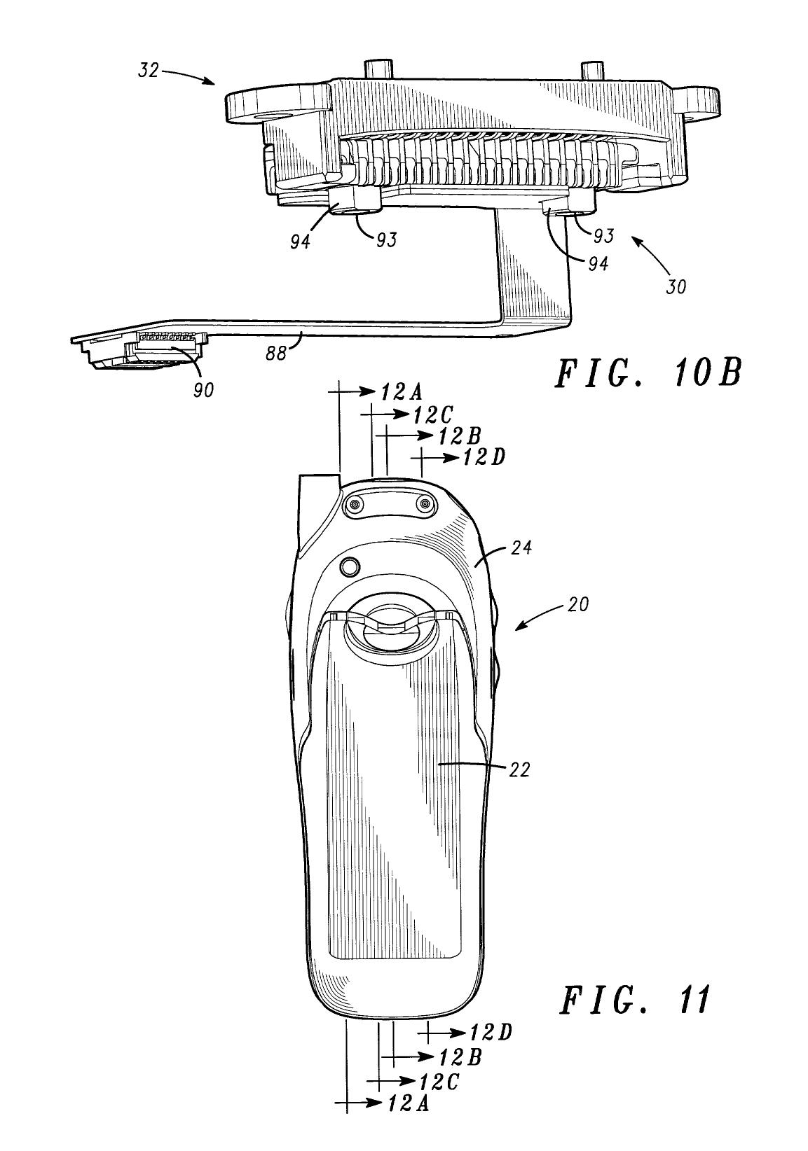

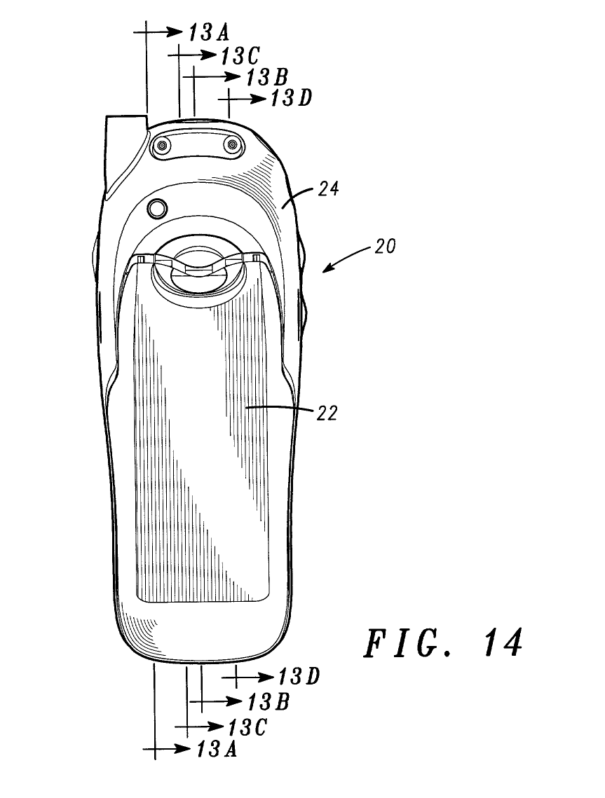

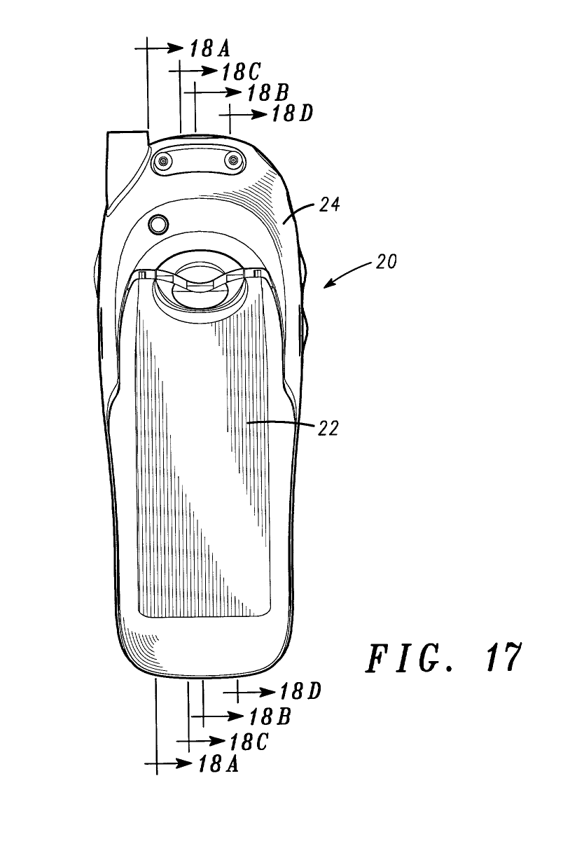

FIGS. 11, 14, and 17 show a back view of the telephone assembly 20 illustrated in FIG. 1 with the smart module 22 and rear phone housing 24 at least partly assembled. However, in order to demonstrate the engagement and disengagement sequence, the smart module 22 is shown in various degrees of upward engagement with the phone rear housing 24 in each of FIGS. 11, 14, and 17. FIG. 11 shows the smart module 22 during an installation or engagement stroke with the module connector sections initially making contact. FIG. 14 shows the module 22 fully engaged with the rear phone housing 24. FIG. 17 shows the module at the beginning of a removal or disengagement stroke where the module connector sections are beginning to dis-engage.

FIGS. 12A-12D illustrate sections through the telephone assembly 20 shown in FIG. 11 and being taken along lines A-A, B-B, C-C, and D-D, respectively. FIGS. 13A-13D are enlarged views of the connector sections 30 and 32 of the telephone shown in FIGS. 12A-12D, respectively. FIG. 13A is a section through the in-turned flanges 74 of the legs 72 and the extensions 92. FIG. 13A shows that the extensions 92 of the in-phone connector body 80 are partially received in the gap between the in-turned flanges 74 of the legs 72 and the module connector body 44 in the partly engaged condition. FIG. 13B illustrates a section through the ground pad 102 and shows the spring contact 60 just making initial contact with the ground pad 102. FIG. 13C shows a section through the signal contact 100 showing the spring contact 60 far from the point of contact or engagement with the signal contact 100 in this initial contact condition of the connector sections. FIG. 13D illustrates the remaining intermediate contacts 86 and their corresponding spring contacts 60 not quite at the point of contact. In this initial contact condition, the ground contact 102 is engaged before any other of the contacts 86 and the signal contact 100.

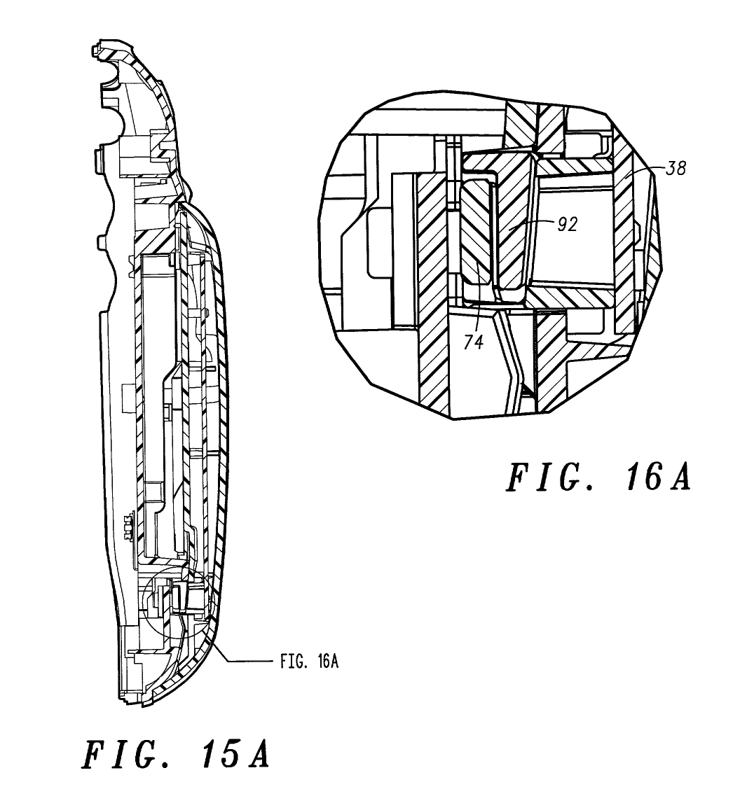

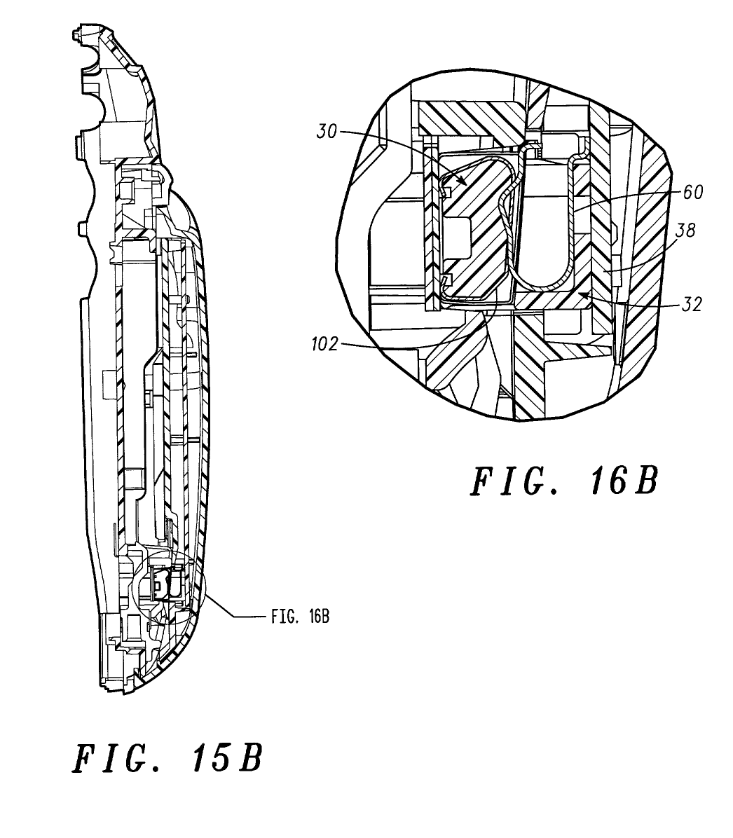

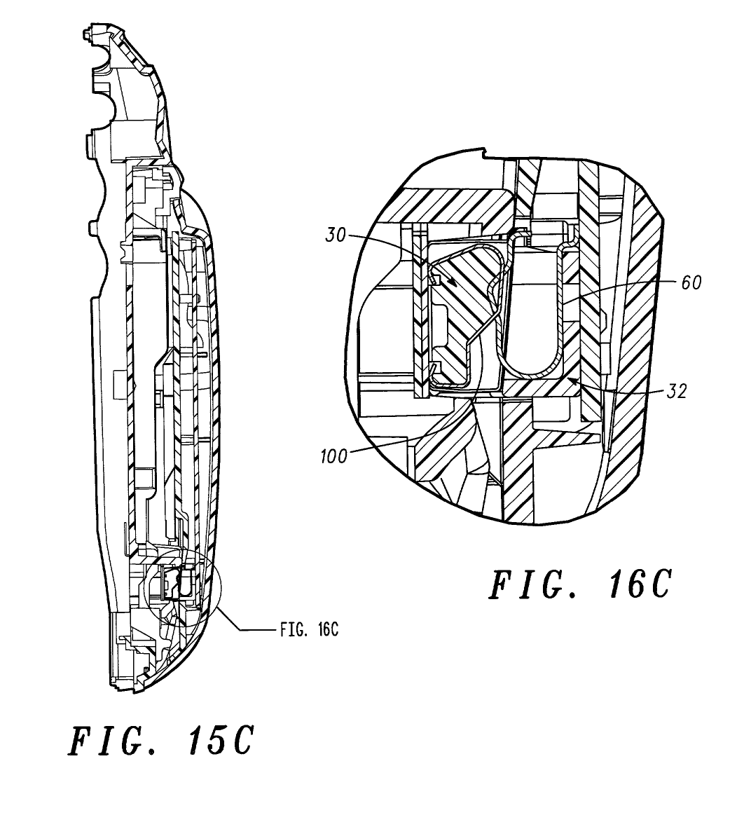

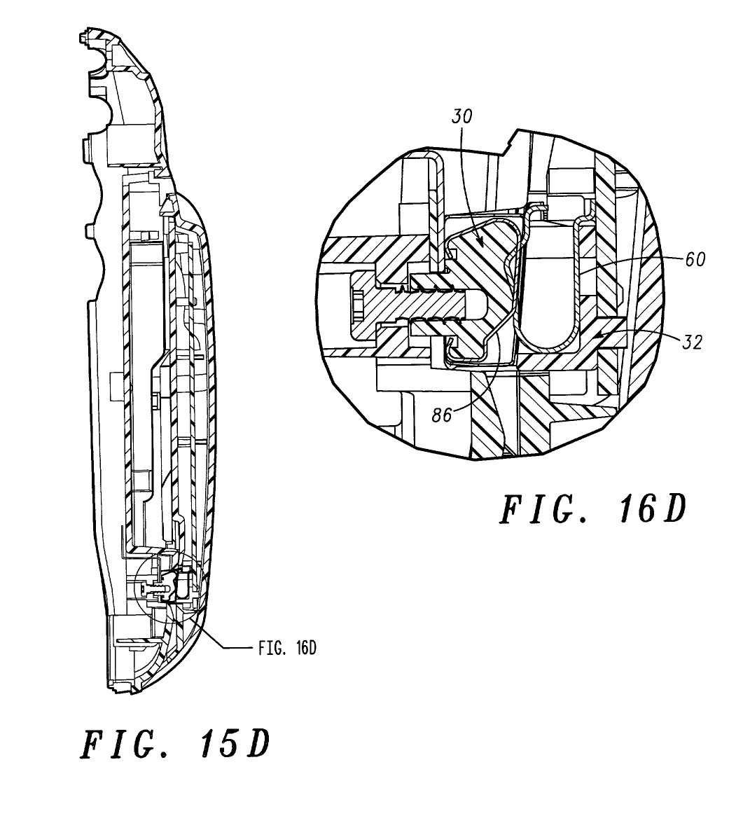

FIGS. 15A-15D illustrate sections through the telephone assembly 20 shown in FIG. 14 with the module 22 fully engaged with the rear phone housing 24. FIGS. 16A-16D are enlarged views of the connector sections of the telephone assembly of FIGS. 15A-15D, respectively. FIG. 16A clearly shows full engagement of the in-turned flange 72 of the legs 74 with the extensions 92. FIG. 16B clearly shows full engagement of the ground pad 102 with its corresponding spring contact 60. FIG. 16C clearly illustrates the signal pad 100 in contact with its corresponding spring contact 60. FIG. 16D clearly illustrates the remaining standard contacts 86 fully engaged with their corresponding spring contacts in the smart module 22.

FIGS. 18A-18D illustrate cross sections through the telephone assembly 20 shown in FIG. 17 with the module 22 partly disengaged from the housing 24. FIGS. 19A-19D are enlarged illustrations of the connector sections 30 and 32 shown in FIGS. 18A-18D, respectively. FIG. 19A shows the slightly disengaged legs and extensions of the two connector sections. FIG. 19B illustrates the ground pad 102 and its corresponding spring contact also nearly fully engaged. FIG. 19C illustrates the signal pad 100 and its corresponding spring contact just after the point of disengagement as the smart module 22 is being removed from the rear housing 24. FIG. 19D illustrates the remaining contacts 86 and corresponding contacts 60 still slightly engaged. Thus, the signal pad or contact 100 disengages first and the ground pad or contact 102 disengages last.

When the smart module 22 is being installed, the ground contact or pad 102 is the first electrical connection and the signal contact or pad 100 is the last electrical connection between the two connector sections 30 and 32. Similarly, when the smart module is being disengaged, the signal contact 100 is the first to disengage and the ground contact 102 disengages last. The staggered contact positions for the contacts 86, 100 and 102 described above accomplish this feature.

As illustrated in FIG. 9, the two connector sections 30 and 32 slidably engage and disengage relative to one another by sliding the confronting surfaces over one another. This example is suitable where the smart module 22 engages the rear phone housing 24 in a sliding manner. For the disclosed example, the confronting surfaces of the connector sections, i.e. the back of the in-phone connector section 30 and the front of the module connector section 32, are arranged generally parallel to the major surfaces of the telephone assembly 20. However, the particular engagement direction and orientation of the two connector sections can vary from that shown and described herein.

The engagement direction and orientation of the connector sections is determined by a number of factors. The type of battery cover and latching or securing mechanism utilized to secure the portable telephone's battery to the rear phone housing 24 are factors. The type of battery can also vary and may also be a factor. The battery may be separate from or integral with a battery cover. The smart module 22 may include its own integral battery. The smart module housing 34, and hence the smart module 22, are intended to attach directly to the battery attachment region 26 of the portable telephone. In doing so, the smart module 22 will cooperate with the phone's battery or battery cover latching mechanism to secure the module on the phone. As will be evident to those skilled in the art, the type of battery, battery cover, and latching mechanism can vary from phone to phone and from telecommunication device to device. Some batteries are attached by moving the battery toward the attachment region in a direction normal to the phone. Other batteries attach by sliding the battery into engagement generally parallel to the attachment region of the phone. Still other batteries are attached at angle between normal and parallel relative to the battery attachment region. The examples disclosed herein are for an attachment procedure that requires the smart module 22 to slide generally parallel to the phone and into engagement with the battery region 26.

If the smart module 22 was required to attach to the attachment region by moving it generally normal to a phone housing surface, the connector sections 30 and 32 can be oriented 90 degrees from that shown in the drawings. Thus, the engaging surfaces of the two connector sections would still slide into engagement with one another as described herein. The various connections between each connector section and its corresponding circuitry would need to be altered somewhat from that described but the connector assembly would essentially remain the same.

The smart module 22 of the present invention can be any type of electronic device that can assist in exchanging data with the telephone, compliment the telephone electronics, upgrade the telephone electronic, or alter the telephone electronics. The smart module can be a device for communicating with a personal organizer of that upgrades the phone to include personal organizer features and information. The smart module can be a short range radio communication device or upgrade for communicating with other such devices. The smart module can be an MP3 player for downloading, storing and playing music or other audio data via the telephone. The smart module can be a memory upgrade device for the telephone. The smart module can be a video camera link or interface, a computer link or interface, a separate display device to compliment the telephone display, an e-commerce device for exchanging personal credit card or financial information with retailers, banks, investment institutions, or other conceivable devices. The smart module can also be a hardwired or wireless link for communicating between the telephone and a personal computer, a computer network, an e-mail account or an Internet account.

The smart module of the present invention is intended to attach to a battery attachment region of the portable telephone using the battery attaching mechanisms provided on the phone. Portable telephones come with a wide variety of battery covers, battery devices, and attaching mechanisms. The present invention is not to be limited to a particular type of these components. The connector assembly of the invention is intended to function with any type of these components. The connector assembly permits the module housing to attach to the telephone housing in the same manner that the removed battery and/or battery cover would attach and yet connect the module printed circuit board to the telephone circuitry.

The connector assembly described herein could be completely reversed and yet properly function. The module connector section could include the flex circuit and the stationary pads as described herein. Likewise, the in-phone connector section could include the spring contacts described herein. In addition, the various legs, tabs, tapered surfaces, and connector body attachment means could be reversed and altered without departing from the spirit and scope of the invention.

Many additional changes and modifications can be made to the examples disclosed herein without departing from the fair scope and spirit of the invention. The scope of some changes is discussed above. The scope of others will become apparent from the appended claims.

What is claimed is:

1. A smart module for connection to a portable telephone, the smart module comprising:
a module housing having a back side and having a front side adapted for removably securing the module housing to a battery attachment region of the portable telephone;
a module printed circuit board; and
a module connector section electronically coupled to the module printed circuit board and being adapted to connect with electronic circuitry of the portable telephone when the module is secured to the telephone.

2. A smart module according to claim 1, further comprising:
a latching mechanism associated with a portion of the module housing for securing the smart module to a battery cover attachment mechanism of the battery attachment region of the portable telephone.

3. A smart module according to claim 1, wherein the module connector section includes a module connector body, a pair of opposed ends, and a plurality of spring contacts carried by the connector body between the opposed ends.

4. A smart module according to claim 3, wherein the connector body further includes a plurality of slots formed adjacent one another wherein one of the plurality of spring contacts is received within a respective one of the plurality of slots.

5. A smart module according to claim 1, wherein the module connector section further comprises:
a module connector body having a pair of opposed ends defining a width between the opposed ends and having a plurality of slots disposed adjacent one another between the opposed ends and oriented transverse relative to the width of the connector body; and
a plurality of spring contacts, each of the plurality of spring contacts being received within a respective one of the plurality of slots, each of the plurality of spring contacts having a U-shape with a resilient portion exposed and extending from the respective slot, and with a curved portion and a straight portion received within the respective slot.

6. A smart module according to claim 5, wherein each of the plurality of spring contacts further includes a first end extending between two tabs of the connector body, each first end having a pair of opposed flared ends overlapping a respective one of the tabs to hold the first end of the spring contact in place relative to the connector body.

7. A smart module according to claim 5, wherein each of the plurality of spring contacts further includes a second end extending from the connector body adjacent the module printed circuit board, each second end defining a pad that is in electrical contact with a portion of the module printed circuit board.

8. A smart module according to claim 1, wherein the smart module is removably secured to the battery attachment region of the portable telephone, and wherein the portable telephone has an in-phone connector section removably and electrically connected to the module connector section.

9. A smart module according to claim 1, further comprising:
a mounting section attached to the module housing and sandwiching the module printed circuit board between the mounting section and the module housing, wherein the module connector section is carried by the mounting section such that a portion of the module connector section is exposed for electrically connecting with a portion of an in-phone connector section of the portable telephone.

10. A smart module according to claim 9, wherein the module connector section includes a plurality of guide openings and the mounting section includes a corresponding plurality of posts each received within a respective one of the plurality of guide openings for properly locating the module connector section relative to the mounting section.

11. A portable telephone comprising:
a telephone housing having a battery attachment region;
electronic telephone circuitry carried by the telephone housing;
a smart module housing removably attached to the battery attachment region of the telephone housing;
a module printed circuit board carried by the module housing;
an in-phone connector section carried by a portion of the telephone housing and having an in-phone connector body and a plurality of electrical in-phone contacts that are electrically connected to the telephone circuitry; and
a module connector section carried by a portion of the smart module and having a module connector body and a plurality of electrical module contacts electrically connected to the module printed circuit board, wherein the in-phone connector section and the module connector section are removably connected to one another with the phone contacts and the module contacts engaged and electrically connected to one another.

12. A portable telephone according to claim 11, further comprising:
a battery cover attachment mechanism on the telephone housing associated with the battery attachment region and that removably secures the module housing to the battery attachment region.

13. A portable telephone according to claim 11, wherein the module connector body includes a pair of opposed ends defining a width between the opposed ends and a plurality of spring contacts carried by the module connector body between the opposed ends, wherein each of the plurality of spring contacts defines a respective one of the plurality of electrical module contacts.

14. A portable telephone according to claim 13, wherein the module connector body further includes a plurality of slots disposed adjacent one another between the opposed ends and oriented transverse relative to the width of the module connector body, and wherein one of the plurality of spring contacts is received within a respective one of the plurality of slots.

15. A portable telephone according to claim 11, wherein the module connector body further comprises:
a pair of opposed ends defining a width of the module connector body between the opposed ends;
a plurality of slots disposed adjacent one another between the opposed ends and oriented transversely relative to the width of the module connector body; and
a plurality of spring contacts each defining a respective one of the plurality of electrical module contacts, wherein each of the plurality of spring contacts is received within a respective one of the slots, and wherein each of the plurality of spring contacts has a U-shape with a resilient portion exposed and extending from the respective slot, and with a curved portion and a straight portion received within the respective slot.

16. A portable telephone according to claim 15, wherein each of the plurality of spring contacts further includes a first end extending between two tabs of the module connector body, each first end having a pair of opposed flared ends overlapping a respective one of the two tabs to hold the first end of each of the plurality of spring contacts in place relative to the module connector body.

17. A portable telephone according to claim 15, wherein each of the plurality of spring contacts further includes a second end extending from the module connector body adjacent the module printed circuit board, each second end defining a pad that is in electrical contact with a portion of the module printed circuit board.

18. A portable telephone according to claim 11, wherein the in-phone connector section further comprises:
a pair of opposed ends defining a width of the in-phone connector body:
a plurality of grooves disposed between the opposed ends of the in-phone connector body and oriented transverse relative to the width; and
a plurality of electrical pads each received in a respective one of the plurality of grooves and defining one of the plurality of in-phone contacts.

19. A portable telephone according to claim 18, wherein one of the plurality of pads defines a signal pad and another of the plurality of pads defines a ground pad.

20. A portable telephone according to claim 19, wherein the signal pad and the ground pad are arranged having transversely staggered positions relative to the other electrical pads and relative to each other.

21. A portable telephone according to claim 18, wherein the in-phone connector section further comprises:
a flexible circuit having a proximal end coupled to the in-phone connector body and having a distal end; and
a remote connector carried on the distal end of the flexible circuit and being electrically connected to each of the in-phone contacts and to the telephone circuitry.

22. A portable telephone according to claim 11, further comprising:
an L-shaped leg extending from each of the pair of opposed ends of the module connector body, each leg having a base and an in-turned flange extending at an angle from the base and defining a gap between the flange and the module connector body; and
an extension extending from each of the opposed ends of the in-phone connector body, each extension being received in a respective one of the gaps.

23. A portable telephone according to claim 18, wherein the grooves and the in-phone electrical pads define an engagement surface of the in-phone connector body that is tapered relative to a corresponding engagement surface of the module connector body in order to slidably engage with the module connector body and the module contacts.

24. A portable telephone according to claim 11, wherein the in-phone connector section is fastened to a portion of the telephone housing such that a portion of the in-phone contacts are exposed and electrically connected to the module contacts.

25. A connector assembly for electronically connecting a smart module to a battery attachment region of a portable telephone, the connector assembly comprising:
an in-phone connector section having an in-phone connector body carried by the portable telephone, a pair of opposed ends defining a width of the in-phone connector body between the opposed ends, and a plurality of electrical telephone contacts carried by the in-phone connector body, wherein the plurality of telephone contacts are electrically connected to telephone electronic circuitry of the portable telephone and wherein a portion of the plurality of telephone contacts are exposed within the battery attachment region;
a module connector section having a module connector body carried by the smart module, a pair of opposed ends defining a width of the module connector body between the opposed ends, and a plurality of electrical module contacts carried by the module connector body, wherein the plurality of module contacts are electrically connected to a printed circuit board of the smart module; and
wherein the in-phone connector section and the module connector section are removably connected to one another when the smart module is attached to the battery attachment region of the portable telephone and whereby the module electrical contacts and the telephone electrical contacts engage and electrically connect with one another.

26. A connector assembly according to claim 25, wherein one of the module and in-phone connector sections further includes a plurality of slots disposed adjacent one another between the opposed ends and oriented transversely relative to the width of the connector body of the one connector section; and
a plurality of spring contacts each defining a respective one of the plurality of electrical contacts of the one connector section, wherein each of the plurality of spring contacts is received within a respective one of the slots, and wherein each of the plurality of spring contacts has a U-shape with a resilient portion exposed and extending from the respective slot and with a curved portion and a straight portion received within the respective slot.

27. A connector assembly according to claim 26, wherein each of the plurality of spring contacts further includes a first end extending between two tabs of the connector body of the one connector section, each first end having a pair of opposed flared ends overlapping a respective one of the two tabs to hold the first end of each of the plurality of spring contacts in place relative to the connector body of the one connector section.

28. A connector assembly according to claim 26, wherein the one connector section is the module connector section.

29. A connector assembly according to claim 28, wherein each of the plurality of spring contacts further includes a second end extending from the module connector body adjacent the module printed circuit board, each second end defining a pad that is in electrical contact with a portion of the module printed circuit board.

30. A connector assembly according to claim 25, wherein one of the module and in-phone connector sections further includes a plurality of grooves disposed between the opposed ends of the connector body of the one connector section and oriented transverse relative to the width, and includes a plurality of electrical pads each received in a respective one of the plurality of grooves and defining one of the plurality of electrical contacts of the one connector section.

31. A connector assembly according to claim 30, wherein one of the plurality of pads defines a signal pad and another of the plurality pads defines a ground pad.

32. A connector assembly according to claim 31, wherein the signal pad and the ground pad are arranged having transversely staggered positions relative to the other electrical pads and relative to each other.

33. A connector assembly according to claim 31, wherein the one connector section is the in-phone connector section.

34. A connector assembly according to claim 33, wherein the in-phone connector section further comprises:
a flexible circuit having a proximal end coupled to the in-phone connector body and having a distal end; and
a remote connector carried on the distal end of the flexible circuit and being electrically connected to each of the in-phone contacts and to the telephone electronic circuitry.

35. A connector assembly according to claim 25, further comprising:
an L-shaped leg extending from each of the pair of opposed ends of the connector body of one of the module and in-phone connector sections, each leg having a base and an in-turned flange extending at an angle from the base and defining a gap between the flange and the connector body of the one connector section; and
an extension extending from each of the opposed ends of the connector body of the other of the module and in-phone connector sections, each extension being received in a respective one of the gaps.

36. A connector assembly according to claim 25, wherein an engagement surface of one of the module and in-phone connector sections that carries the electrical contacts of the one connector section is tapered relative to a corresponding engagement surface of the other connector section that carries the electrical contacts of the other connector section in order to that the module and in-phone electrical contacts can slidably engage with one another.
